(19) United States
(12) Patent Application Publication
(10) Pub. No.: US 2008/0181387 A1
(43) Pub. Date: Jul. 31, 2008

(54) TELEPHONE SYSTEM AND SERVER APPARATUS

(75) Inventor: Takeo Watanabe, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/021,837

(22) Filed: Jan. 29, 2008

(30) Foreign Application Priority Data
Jan. 31, 2007 (JP) 2007-021194

(51) Int. Cl. H04M 7/00

(52) U.S. Cl. 379/225

(57) ABSTRACT

According to one embodiment, a telephone system includes a plurality of telephone exchange apparatuses which execute exchange processing among a plurality of telephone terminals and a server apparatus which is connected to the plurality of telephone exchange apparatuses via transmission paths, receives a call information event to specify a plurality of telephone terminals to be call-connected, and executes a computer supported telephony application with prescribed standards regarding call state management of the plurality of telephone terminals, wherein the server apparatus includes a controller which returns a telephone terminal which has become an extra state of the standards to a state in the standards, when the sate in the standards changes into the extra state of the standards in a state in which call connections among a plurality of telephone terminals connected to telephone exchange apparatuses different from one another.

### CROSS-REFERENCE TO RELATED APPLICATIONS

This application is based upon and claims the benefit of priority from Japanese Patent Application No. 2007-021194, filed Jan. 31, 2007, the entire contents of which are incorporated herein by reference.

### BACKGROUND

1. Field

One embodiment of the present invention relates to a telephone system and a server apparatus which performs operation management via an Internet Protocol (IP) network to a plurality of telephone exchange apparatuses connected with one another via the IP network by using a server apparatus.

2. Description of the Related Art

In recent years, an IP telephone system which interactively transmits and receives images and voice as packet data in real time via the IP network has become widely used. The IP telephone system may perform inter-extension communication and outside-line origination and termination for each of telephone exchange apparatuses to be connected to the IP network and also may perform inter-extension communication and outside-line origination and termination among the telephone exchange apparatuses via the IP network.

Meanwhile, also in the IP telephone system, adoption of computer telephony integration (CTI) for actualizing a system with a high function is a possible approach. The CTI connects a server apparatus such as a personal computer to each telephone exchange apparatus via the IP network, makes the server apparatus perform a part of exchange processing of each telephone exchange apparatus, store and process voice and data, and may achieve the system with the high function without having to enhance processing function of each of the telephone exchange apparatuses. The server apparatus has a function of executing a computer supported telephony application (CSTA) provided from European Computer Manufacturer Association (ECMA) and related to call state management of a plurality of telephone terminals.

Conventionally, a system has been proposed, in which a server apparatus is connected to a plurality of telephone exchange apparatuses via a communication network, the server apparatus may be shared with a large number of telephone exchange apparatuses, hold sounds are notified to telephone terminals from the server apparatus through the telephone exchange apparatuses to disconnect speech channels being in hold (e.g., Jpn. Pat. Appln. KOKAI Publication No. 2006-67048).

However, in the aforementioned system, telephone terminals, which are connected to telephone exchange apparatuses different from one another, bring about speech states one another then if they bring about extra states of the ECMA, namely hold states, or hold transfer states with respect to one another, the telephone terminals pose unnecessary hold states of lines. Thereby, limited lines are brought into busy states. If it is tried to avoid these states only by mutual systems, there is some possibility that state notification miss each other due to connection environments on the IP network, and that the systems perform card processing for mutual telephone terminals.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic configuration view illustrating the first embodiment of a telephone system regarding the present invention;

FIG. 2 is a view illustrating a preferred example of storage content in a database of a CSTA monitoring control application shown in FIG. 1;

FIG. 3 is a schematic sequence view illustrating transmission and reception operations of information among terminals, telephone exchange apparatuses and a server in performing CSTA monitoring control in the first embodiment;

FIG. 4 is a detailed sequence view of FIG. 3;

FIG. 5 is a flowchart illustrating control processing procedure of a call processing control unit when a user erroneously performs a terminal disconnection operation in the first embodiment;

FIG. 6A is a view illustrating a CSTA call model when the terminal transits from a speech state to a hold state or a hold transfer state as the second embodiment of the invention;

FIG. 6B is a view illustrating a CSTA call model when the telephone system transits from the hold state or hold transfer state to the speech state as the second embodiment of the invention; and

FIG. 7 is a view illustrating a CSTA model sequence in the second embodiment of the invention.

### DETAILED DESCRIPTION

Various embodiments according to the invention will be described hereinafter with reference to the accompanying drawings. In general, according to one embodiment of the invention, a telephone system comprising: a plurality of telephone exchange apparatuses which execute exchange processing among a plurality of telephone terminals: and a server apparatus which is connected to the plurality of telephone exchange apparatuses via transmission paths, receives a call information event to specify a plurality of telephone terminals to be call-connected, and executes a computer supported telephony application with prescribed standards regarding call state management of the plurality of telephone terminals, wherein the server apparatus includes a controller which returns a telephone terminal which has become an extra state of the standards to a state in the standards, when the sate in the standards changes into the extra state of the standards in a state in which call connections among a plurality of telephone terminals connected to telephone exchange apparatuses different from one another.

### FIRST EMBODIMENT

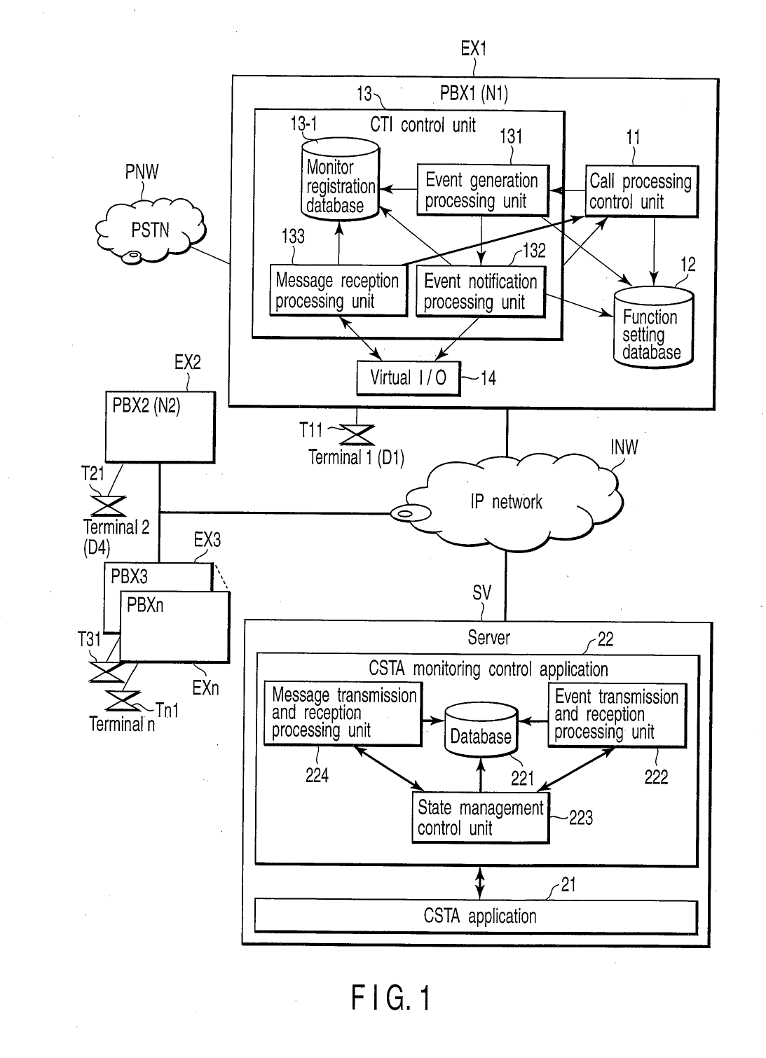

FIG. 1 shows a schematic configuration view depicting the first embodiment of a telephone system regarding the invention. The system includes an IP network INW. A plurality of telephone exchange apparatuses (PBX) EX1-EXn (n is a natural number) are connected to the IP network INW. A server SV is connected to the IP network INW.

Each of terminals T11, T21, T31 . . . Tn1 is connected to the plurality of PBXs EX1-EXn, respectively. Each of the terminals T11, T21, T31 . . . Tn1 uses an IP telephone terminal having a speech processing function and a media information processing function or a software-telephone achieved by software on a personal computer. Further, the telephone exchange apparatus EX1 is connected to an analog telephone network PNW.

Each of the telephone exchange apparatuses EX1-EXn includes a call processing control unit 11, a function setting database 12, a CTI control unit 13 and a virtual I/O 14. Here, the telephone exchange apparatus EX1 will be described as a representative.

The control unit 11 has usual control functions, such as transmission processing accompanied by a call request of each of the terminals T11, T21 . . . Tn1, usual incoming call processing accompanied by outside line incoming calls from the analog telephone network PNW and transfer processing among terminals T11, T21 . . . Tn1 on the IP network INW, with reference to storage content of the database 12.

The CTI control unit 13 has a function of transfer processing of digital voice signals between the server SV and the terminal T11 via the virtual I/O 14 and a function of transfer processing of control command etc., between the control unit 11 and the server SV.

The server SV includes a CSTA application 21 and a CSTA monitoring control application 22 (hereinafter, referred to as a control application 22). The CSTA application 21 receives a call information event specifying each of the terminals T11-Tn1 to be call-connected from the telephone exchange apparatuses EX1-EXn, respectively, and executes the CSTA of the ECMA standards regarding call state management of each of the terminals T11-Tn1.

The control application 22 includes a database 221, an event transmission and reception processing unit 222 (hereinafter, referred to as a processing unit 222), a state management control unit 223 (hereinafter, referred to as a control unit 223), and a message transmission and reception processing unit 224 (hereinafter, referred to as a processing unit 224).

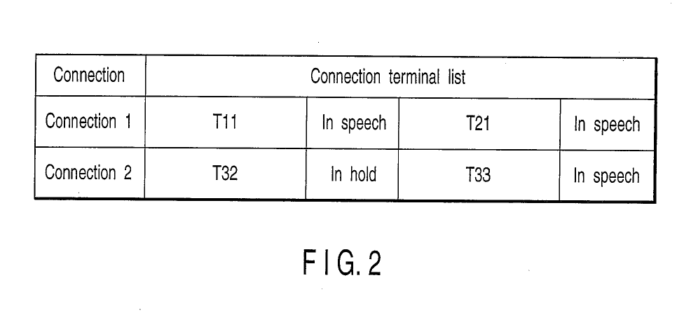

Data indicating correspondence relationships between each item of device information of the terminals T11-Tn1 and state information indicating connection states is stored in the database 221, as shown in FIG. 2.

The processing unit 222 analyzes the call information event notified from the telephone exchange apparatus EX1 to determine, for example, the terminal T11 and the terminal T21 has been in speech, and adds to update information about ‘connection 1’ in the database 221.

The control unit 223 monitors the call state of each of the terminals T1-Tn1 by referring to storage content in the database 221, and when receiving a call information event (a ‘Held’ event) indicating a hold state of the terminal T21 from the telephone exchange apparatus EX2, for example, in speech between the terminal T11 and the terminal T21, if the terminal T11 is in hold, the control unit 223 makes the processing unit 224 transmit a ‘Retrieve Call’ message to the terminal T21.

Next, operations of the system configured as given above will be described.

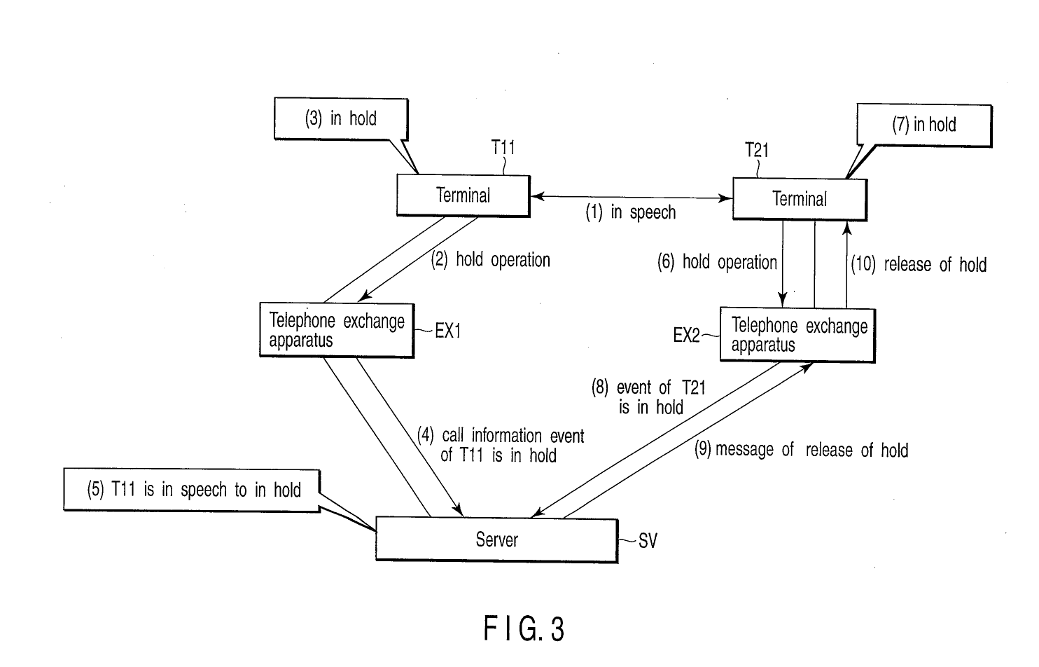

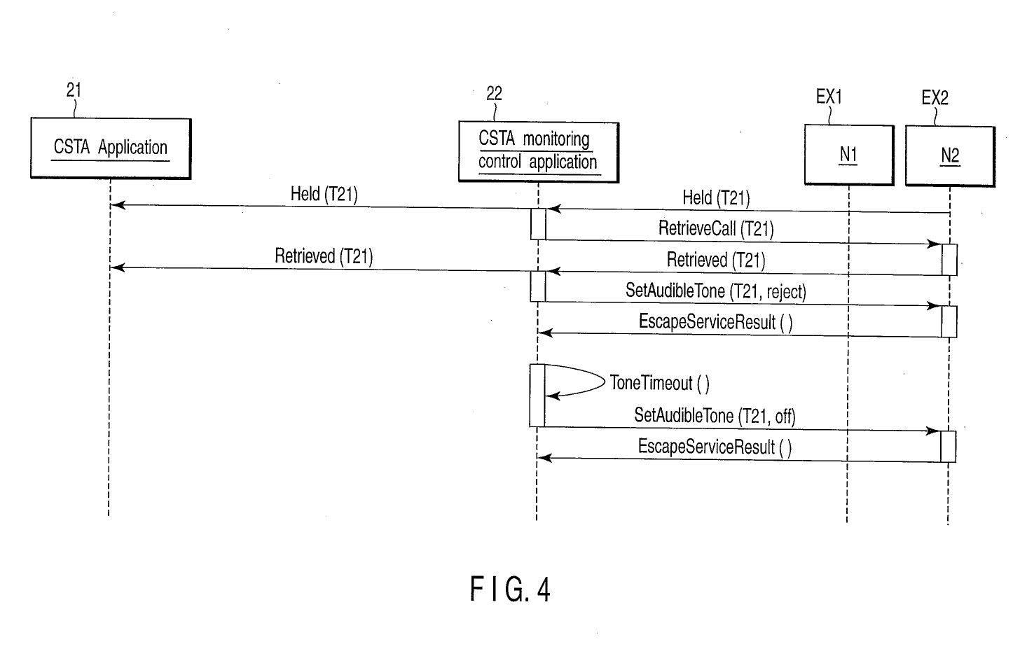

FIG. 3 shows a schematic sequence view depicting transmission and reception operations among the terminals T11, T21, the telephone exchange apparatus EX1, EX2 and the server SV in performing the CSTA monitoring control. FIG. 4 shows its detailed sequence view.

It is assumed that speech has been made between terminals T11 and T21 [FIG. 3 (1)]. In this state, it is assumed that a user operates a request for hold from the terminal T11 [FIG. 3(2)]. The terminal T11 then transmits the request signal to the telephone exchange apparatus EX1. When receiving the request signal for hold, the telephone exchange apparatus EX1 holds a communication link to and from the terminal T21 [FIG. 3(3)], and makes the control unit 11 transmit an event generation instruction to the CTI control unit 13.

An event generation processing unit 131 at the CTI control unit 13 generates the ‘Held’ event to notify the generated event to an event notification processing unit 132. The notification processing unit 132 transmits the event to the virtual I/O 14. The virtual I/O 14 transmits the ‘Held’ event to the control application 22 via the IP network INW {FIG. 3(4)}.

When the control application 22 receives the ‘Held’ event from the telephone exchange EX1, the ‘Held’ event is notified to the processing unit 222. The processing unit 222 then re-generates an event to notify the CSTA application 21. After the re-generation, the data is transferred to the processing unit 222, and the processing unit 222 notifies the ‘Held’ event to the CSTA application 21.

Thereby, the CSTA application 21 recognizes that the terminal T11 is in hold state. The control unit 223 performs event determining processing. In the case of ‘Held’ event, the control unit 223 determines whether or not a speech partner is in hold state, or hold transfer state, and if the speech partner is in hold state or hold transfer state, the control unit 223 generates a ‘Retrieved Call’ message for an event transmission origin, and the processing unit 224 transmits the ‘Retrieved Call’ message. If the speech partner is not in hold state or hold transfer state, the control unit 223 does not do anything. In the case at this time, since the speech partner is not in hold state or hold transfer state, the control unit 223 does not do anything.

In the given state, when the terminal T21 conducts the hold operation, each control unit and each processing unit of the telephone exchange apparatus EX2 perform the same operations as those of the terminal T11 being held, and transmits the ‘Held’ event to the control application 22. In the control application 22 which has received the event, the processing unit 222 transmits the re-generated ‘Held’ event to the CSTA application 21. Since the speech partner (terminal T11) is in hold state, the control unit 223 transmits the ‘Retrieve Call’ message to the terminal T21.

In the telephone exchange apparatus EX2 which has received the ‘Retrieve Call’ message, the message reception processing unit 133 notifies the ‘Retrieve Call’ message to the call processing control unit 11 so as to return the terminal T21 to the original speech state by the control unit 11. The control unit 11 notifies the ‘Retrieve Call’ message to the event generation processing unit 131 and generates a ‘Retrieved’ event to transmit it to the control application 22.

The control application 22 which has received the ‘Retrieved’ event transmits a re-generated ‘Retrieved’ event to the CSTA application 21 through the processing unit 222. In the control unit 223, the processing unit 222 transmits the ‘Retrieve Call’ message, and also when receiving the ‘Retrieved’ event, sets an ‘Audible Tone’ timer, and transfers a ‘Set Audible Tone’ ringing message to the terminal T21.

In the telephone exchange apparatus EX2 which has received the ‘Set Audible Tone’ ringing message, the message reception processing unit 133 transmits an ‘Escape Service Result’ message to the control application 22. When receiving the ‘Set Audible Tone’ ringing message, the terminal T21 of the telephone exchange apparatus EX2 starts disconnection tone ringing.

After this, time out of the ‘Audible Tone’ timer which has been stored in the control application 22, a ‘Set Audible Tone’ stop message is transmitted to the terminal T21.

The telephone exchange apparatus EX2 which has received the ‘Set Audible Tone’ stop message makes the message reception processing unit 133 transmit the ‘Escape Service Result’ to the control application 22. By receiving the ‘Set Audible Tone’ stop message, the terminal T21 of the telephone exchange apparatus EX2 stops the disconnection tone ringing.

Here, if the user is not awake to the fact that the terminal 21 of the telephone exchange apparatus EX2 has been returned to the original speech state and conducts a terminal disconnection operation, the call processing control unit 11 executes the control processing shown in FIG. 5.

If the terminal T21 conducts the disconnection operation, the control unit 11 in the telephone exchange apparatus EX2 determines whether or not the system is in a ‘loud-speaker-telephone speech state 2’ (block ST5a). The system regarding the present invention determines whether the terminal T21 has already been prevented from being disconnected erroneously.

Here, if the terminal T21 is in the ‘loud-speaker-telephone speech state 2’ (Yes), the control unit 11 conducts the existing disconnection processing (block ST5b).

In contrast, if the terminal T21 is not in the ‘loud-speaker-telephone speech state 2’ (No), there is some possibility that the terminal T21 is in the state of the terminal disconnection operation due to erroneous disconnection, or in the state of the usual speech disconnection operation. The call processing control unit 11 then determines whether or not the ‘Set Audible Tone’ ringing message has been received (block ST5c). Here, if the ‘Set Audible Tone’ ringing message has not been received, since the terminal T21 is in the usual speech disconnection operation, the terminal T21 conducts the existing disconnection processing.

On the contrary, if the ringing message has been received (Yes), since the control unit 11 makes the terminal T21 be in the state of the ‘loud-speaker-telephone speech state 2’ because the terminal T21 has done the disconnection operation erroneously, and switchovers the state of the terminal T21 into the ‘loud-speaker-telephone speech state 2’ (block ST5d).

As mentioned above, in the first embodiment, the server SV monitors whether or not the call connection between the terminals T11, T21 has been established and has been in a multiple hold state by means of the control application 22 prior to the execution of the processing through the CSTA application 21, and then, returns the terminal T21, which has been in the hold state afterward, to the original sate.

Accordingly, even when the terminals T11, T21 have become hold states mutually from the speech state therebetween on the IP network INW, the server SV may avoid guard processing for the terminals T11, T21. The server SV may use the existing CSTA application 21.

Since the first embodiment is configured to notify the fact that the terminal T21, which has been returned to the original speech state through the guard processing, is retuned to the original state to the user by a disconnection tone, the user may confirm of performing erroneous operation.

Further, in the first embodiment, after the terminal T21 is returned to the original state, in a case of disconnection operation, since the terminal T21 is set into the ‘loud-speaker-telephone speech state 2’ once, the disconnection operation may be prevented.

### SECOND EMBODIMENT

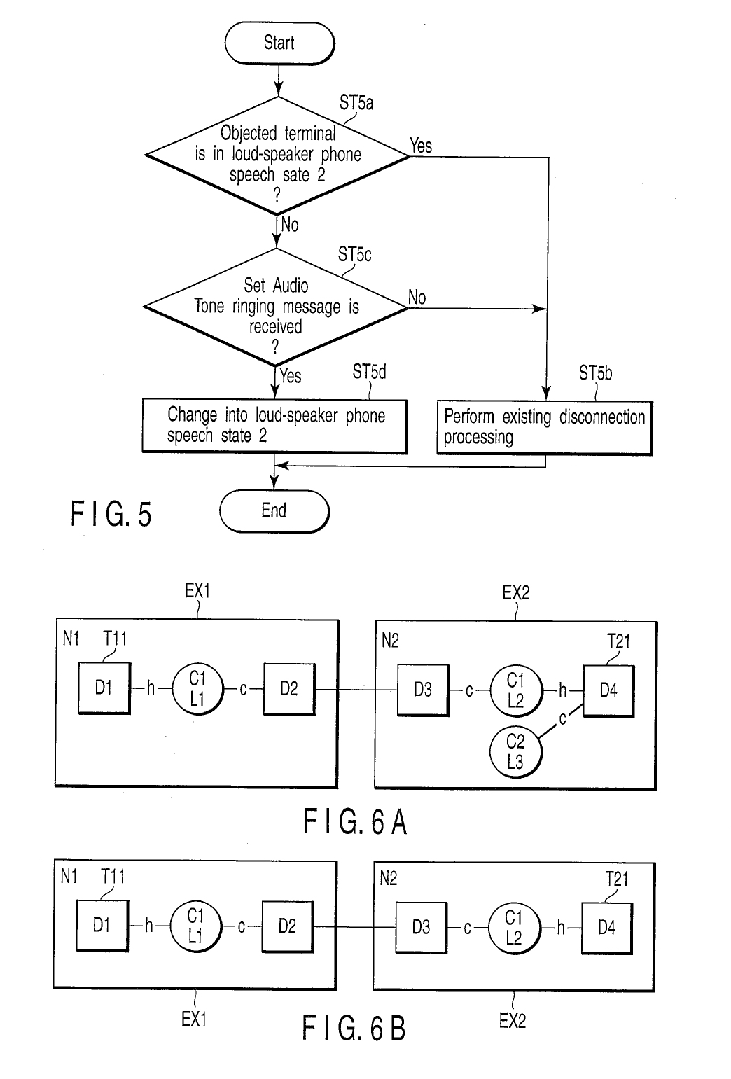

FIG. 6A and FIG. 6B depict a CSTA call model as the second embodiment of the invention.

FIG. 6A depicts the state that in a speech states between the terminal T11 (N1D1) and the terminal T21 (N2D4), the terminal T11 becomes a hold state and then the terminal T21 becomes a hold transfer state.

In such a case, since the system is brought into a state in which the terminal T11 becomes the hold state or the hold transfer state and the terminal T21 becomes the hold transfer state, a hold transfer state between terminals N2D4-N2C1 is returned to the original state to be brought into the state shown in FIG. 6B.

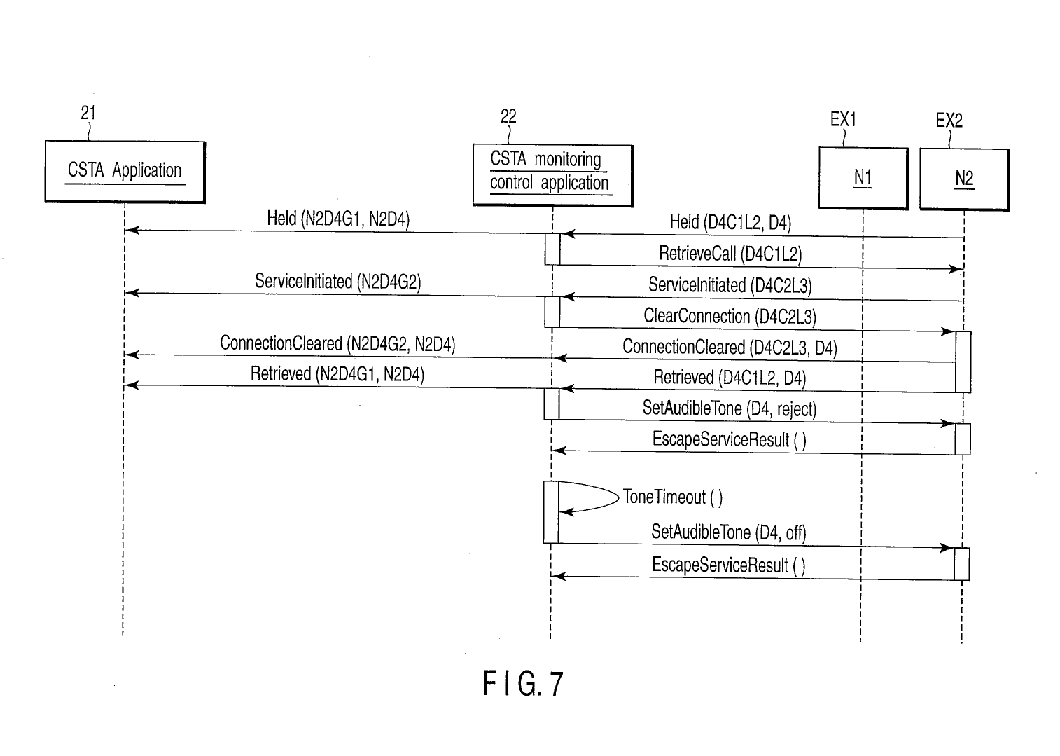

FIG. 7 shows a view illustrating a CSTA model sequence. Here, behavior of each control unit is omitted and a CSTA message and an event are described.

FIG. 7 shows the sequence in accordance with such prior conditions that after the terminals T21 performs a hold transfer operation in the case in which the terminals T11, T21 are in a speech state via the IP network INW and the terminal T11 is in a hold state or a hold transfer.

When receiving the ‘Held’ event from the telephone exchange apparatus EX2, the control application 22 transmits a ‘Held’ event with the same content to the CSTA application 21. Further, the control application 22 transmits the ‘Retrieved Call’ message to the terminal T21.

At this moment, since the terminal T21 is already in the hold transfer state, the terminal T21 may not be returned to the original speech state. Moreover, the terminal T21 transmits a ‘Service Initiated’ event.

The control application 22 which has received the ‘Service Initiated’ event transmits a ‘Service Initiated’ event with the same content to the CSTA application 21. Furthermore, the control application 22 transmits a ‘Clear Connection’ message to the terminal T21. Thereby, the terminal T21 is returned to the original speech state.

The telephone exchange apparatus EX2 which has received the ‘Clear Connection’ message transmits a ‘Connection Cleared’ event and a ‘Retrieved’ event to the control application 22.

The control application 22 which has received the ‘Connection Cleared’ event and the ‘Retrieved’ event transmits a ‘Connection Cleared’ event and a ‘Retrieved’ event with the same content to the CSTA application 21. Moreover, the control application 22 transmits a ‘Set Audible Tone’ ringing message to the terminal T21. Thereby, the terminal T21 starts disconnection tone ringing.

The telephone exchange apparatus EX2 which has received the ‘Set Audible Tone’ ringing message transmits the ‘Escape Service Result’ event to the control application 22.

After this, by ‘Set Audible Tone’ timer time-out of an internal timer in the control application 22 transmits the ‘Set Audible Tone’ stop message toward the terminal T21. Thereby, the terminal T21 stops the disconnection tone ringing.

When receiving the ‘Set Audible Tone’ stop message, the telephone exchange apparatus EX2 transmits the ‘Escape Service Result’ event to the control application 22.

As mentioned above, the second embodiment also produces the same operational effect as that of the first embodiment.

### OTHER EMBODIMENT

The present invention is not limited to each of the foregoing embodiments. For instance, while each of the aforementioned embodiments has been described the case in which avoidance control for the multiple hold state and avoidance control for the multiple hold transfer state are executed as examples, other than this, in the case in which the state in the ECMA standards is changed into the state in the extra ECMA standards, the terminals which have been brought into the state in the extra ECMA standards may be returned to the state in the ECMA standards.

Other than this, a system configuration, a functional configuration of a server, types of terminals, storage content of each procedure and its content of a database, each procedure and its content of avoidance control for a multiple hold state and of avoidance control for a multiple hold transfer state, etc., may be embodied in a various modifications without departing from the concept of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system comprising:
a plurality of telephone exchange apparatuses which execute exchange processing among a plurality of telephone terminals: and
a server apparatus which is connected to the plurality of telephone exchange apparatuses via transmission paths, receives a call information event to specify a plurality of telephone terminals to be call-connected, and executes a computer supported telephony application with prescribed standards regarding call state management of the plurality of telephone terminals, wherein
the server apparatus includes a controller which returns a telephone terminal which has become an extra state of the standards to a state in the standards, when the sate in the standards changes into the extra state of the standards in a state in which call connections among a plurality of telephone terminals connected to telephone exchange apparatuses different from one another.

2. A server apparatus which receives a call information event to specify a plurality of telephone terminals to be call-connected from a plurality of telephone exchange apparatuses to execute exchange processing among a plurality of telephone terminals and executes a computer supported telephony application of prescribed standards regarding call state management of the plurality of telephone terminals, comprising:
a controller which returns a telephone terminal which has become an extra state of standards to a state in original standards, when the telephone terminal changes from the state in the standards into the extra state of the standards in a state in which call connections are established among plurality of telephone terminals connected to telephone exchange apparatus different from one another.

3. The server apparatus according to claim 2, wherein after a first telephone terminal among the plurality of telephone terminals in which the call connections are established becomes a hold state or a hold transfer state when a second telephone terminal to be a speech partner of the first telephone terminal becomes into a hold state, the controller returns the second telephone terminal from the hold state to an original call connection state.

4. The server apparatus according to claim 2, wherein after a first telephone terminal among the plurality of telephone terminals in which the call connections are established becomes a hold state or a hold transfer state when a second telephone terminal to be a speech partner of the first telephone terminal becomes into a hold transfer state, the controller returns the second telephone terminal from the hold state to an original call connection state.

5. The server apparatus according to claim 2, wherein the controller notifies a disconnection notification tone to the telephone terminal which has been returned to the original call connection state.

6. The server apparatus according to claim 2, wherein the controller includes a unit to disable a disconnection operation when the telephone terminal which has been returned to the original call connection state performs the disconnection operation.
